(19) United States
(12) Patent Application Publication
(10) Pub. No.: US 2024/0079632 A1
(43) Pub. Date: Mar. 7, 2024

(54) ENERGY STORAGE DEVICE AND METHOD OF USING ENERGY STORAGE DEVICE

(71) Applicant: GS Yuasa International Ltd., Kyoto-shi, Kyoto (JP)

(72) Inventors: Kazuya OKABE, Kyoto-shi, Kyoto (JP); Ryoichi OKUYAMA, Kyoto-shi, Kyoto (JP)

(21) Appl. No.: 18/262,649

(22) PCT Filed: Nov. 10, 2021
(86) PCT No.: PCT/JP2021/041281

§ 371 Date: Jul. 24, 2023

(30) Foreign Application Priority Data
Jan. 29, 2021 (JP) 2021-013223

(51) Int. Cl. H01M 10/04; H01M 50/209

(52) U.S. Cl. CPC H01M 10/0431; H01M 50/209

(57) ABSTRACT

An energy storage device includes a wound electrode assembly containing lithium manganese oxide as a main component in a positive active material, and a case that houses the wound electrode assembly. The wound electrode assembly includes a mixture layer forming portion in which a mixture layer is formed, and a mixture layer non-forming portion located at least at one end in a first direction parallel to a winding axis. In the wound electrode assembly, a ratio of a dimension in the first direction to a dimension in a second direction orthogonal to the first direction in plan view is 1.45 or more.

### CROSS REFERENCE TO RELATED APPLICATIONS

This application is a National Stage Application, filed under 35 U.S.C. § 371, of International Application No. PCT/JP2021/041281, filed Nov. 10, 2021, which international application claims priority to and the benefit of Japanese Application No. 2021-013223, filed Jan. 29, 2021; the contents of both of which as are hereby incorporated by reference in their entireties.

### BACKGROUND

### Technical Field

The present invention relates to an energy storage device and a method of using the energy storage device.

### Description of Related Art

In recent years, energy storage devices such as lithium ion secondary batteries have been used in a wide range of fields such as power sources for portable terminals such as notebook personal computers and smartphones, renewable energy storage systems, and IoT device power sources. The energy storage device is actively developed as a power source for a next-generation clean energy vehicle such as an electric vehicle (EV), a hybrid electric vehicle (HEV), or a plug-in hybrid electric vehicle (PHEV).

As a positive active material of the lithium ion secondary battery, a lithium transition metal composite oxide such as lithium cobalt oxide, lithium nickel oxide, or lithium manganese oxide is used (see, for example, Patent Document JP-A-2003-157844).

In order to reduce a dead space in a case and to improve energy density of the energy storage device, various structures have been proposed (see, for example, Patent Document JP-A-2019-003880).

### BRIEF SUMMARY

Conventionally, in a lithium ion battery, a so-called winding-type electrode assembly in which a long positive electrode plate and a long negative electrode plate are stacked with a long separator interposed therebetween and the stacked product is wound is often used. The winding-type electrode assembly is easily manufactured at low cost.

However, the winding-type electrode assembly is generally considered to be unsuitable for improvement of energy density because a component for current collection (a current collector which is a metal plate component or the like) occupies a relatively large space in the case.

An object of the present disclosure is to provide an energy storage device which uses a wound electrode assembly and has improved characteristics, and a method of using the energy storage device.

An energy storage device according to one aspect of the present disclosure includes: a wound electrode assembly containing lithium manganese oxide as a main component in a positive active material; and a case that houses the wound electrode assembly. The wound electrode assembly includes a mixture layer forming portion in which a mixture layer is formed, and a mixture layer non-forming portion located at least at one end in a first direction parallel to a winding axis. In the wound electrode assembly, a ratio of a dimension in the first direction to a dimension in a second direction orthogonal to the first direction in plan view is 1.45 or more.

According to the present disclosure, it is possible to provide an energy storage device which uses a wound electrode assembly and has improved characteristics, and a method of using the energy storage device.

### BRIEF DESCRIPTION OF THE FIGURES

FIG. 1 is a perspective view showing an energy storage apparatus including an energy storage device according to an embodiment.

FIG. 2 is an exploded perspective view showing a configuration example of the energy storage device.

FIG. 3 is a schematic view showing a configuration example of an electrode assembly.

FIG. 4 is an explanatory view for explaining the configuration example of the electrode assembly.

FIG. 5 is a charge-discharge curve showing a relationship between an SOC and a voltage for an LMO battery.

FIG. 6 is a charge-discharge curve showing the relationship between the SOC and the voltage for an LFP battery.

### DETAILED DESCRIPTION OF VARIOUS EMBODIMENTS

An energy storage device includes a wound electrode assembly containing lithium manganese oxide as a main component in a positive active material, and a case that houses the wound electrode assembly. The wound electrode assembly includes a mixture layer forming portion in which a mixture layer is formed, and a mixture layer non-forming portion located at least at one end in a first direction parallel to a winding axis. In the wound electrode assembly, a ratio of a dimension in the first direction to a dimension in a second direction orthogonal to the first direction in plan view is 1.45 or more. The ratio of the dimension in the first direction to the dimension in the second direction may be 1.82 or more.

In the present specification, the “winding axis” may be a virtual axis as the center of winding, or may be a physical axis such as a winding core. From the viewpoint of improving an energy density, the winding axis is preferably a virtual linear axis.

In the present specification, the “plan view” refers to a case where the wound electrode assembly, which is housed in the case and cannot be visually recognized, is viewed from a third direction, orthogonal to said first direction and said second direction, after the wound electrode assembly is taken out from the case or before the wound electrode assembly is housed in the case.

The mixture layer non-forming portion may be provided only at one end of the wound electrode assembly in the first direction, or may be provided at both ends of the wound electrode assembly in the first direction. In the latter case, the mixture layer forming portion is provided between the mixture layer non-forming portions.

The ratio of the dimension is, for example, 1.45 when the wound electrode assembly has a first direction dimension of 196.65 mm and a second direction dimension of 135.60 mm in plan view, and is, for example, 1.82 when the wound electrode assembly has a first direction dimension of 246.65 mm and a second direction dimension of 135.60 mm in plan view.

When a wound electrode assembly in which the ratio of the dimension in the first direction to the dimension in the second direction is 1.45 or more and which is long in the first direction is used, and is housed in a long case similar to the wound electrode assembly, a ratio of a space in the case occupied by a current collecting component to a volume of the case can be reduced. It is possible to provide an energy storage device in which a ratio of the volume occupied by the wound electrode assembly to the volume of the case (so-called volume occupancy) is improved and the energy density is improved.

However, when the wound electrode assembly which is long in the first direction is used and charge and/or discharge is performed through the mixture layer non-forming portion located at one end of the wound electrode assembly, a reaction hardly occurs in a portion of the wound electrode assembly which is far from the mixture layer non-forming portion due to an influence of electric resistance up to the portion. For example, in the case of a lithium ion battery, a lithium ion insertion/detachment reaction hardly occurs. In other words, when a long wound electrode assembly is used, variations in reaction are likely to occur in the electrode assembly (uneven distribution of lithium ions are likely to occur).

As in the above configuration, when the electrode assembly containing lithium manganese oxide as a main component in the positive active material is used, the reaction variation in the electrode assembly is naturally eliminated when the energy storage device is brought into an unenergized state (for example, when the energy storage device is left standing).

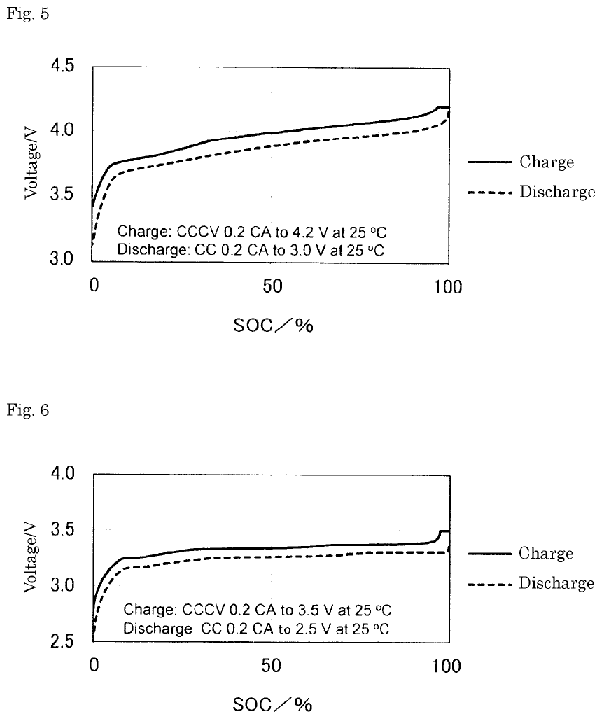

The reason for this will be described in comparison between an energy storage device (for example, an LMO battery) having the electrode assembly containing lithium manganese oxide as a main component in the positive active material and an energy storage device (for example, an LFP battery) including the electrode assembly containing lithium iron phosphate as a main component in the positive active material. FIG. 5 is a charge-discharge curve showing a relationship between SOC (State of Charge: charge state) and a voltage for an LMO battery. FIG. 6 is a charge-discharge curve showing the relationship between the SOC and the voltage for an LFP battery. The horizontal axis represents SOC (%), and the vertical axis represents voltage (V). A solid line in the drawings indicates a charge curve, and a broken line indicates a discharge curve. Although not illustrated, a curve indicating an OCV (Open Circuit Voltage) is located substantially in the middle of the charge curve and the discharge curve. The OCV is a voltage of the battery when the voltage of the battery is not affected by polarization or is negligibly small, such as when a state in which no charge-discharge current flows continue. The negative electrode of the LMO battery and the LFP battery is graphite.

As shown in FIG. 5, in the LMO battery, the charge-discharge curve has a gradient over a wide range of its SOC (has a voltage difference corresponding to a change in SOC). Thus, even if the reaction variation occurs in the electrode assembly, when no energization is performed, electricity flows in the electrode assembly from a portion where a charge reaction proceeds and the voltage becomes high to a portion where the charge reaction does not proceed and the voltage remains low, and the reaction variation is eliminated.

By way of comparison, in the LFP battery shown in FIG. 6, the voltage hardly changes over a wide range of its SOC (a plateau region with an extremely small gradient). Thus, a voltage difference hardly occurs between the portion where the charge reaction has proceeded and the portion where the charge reaction has not proceeded, and therefore, the reaction variation in the electrode assembly is hardly eliminated even in the unenergized state. When charge and discharge are resumed in a state where the reaction variation is not eliminated, the reaction variation in the electrode assembly is further promoted. This tendency is particularly remarkable under a low temperature environment. Therefore, by using a wound electrode assembly containing, as a main component, a lithium transition metal having a gradient in a wide range of SOC in the charge-discharge curve, such as lithium manganese oxide, in the positive active material, it is possible to reduce the reaction variation in the wound electrode assembly which is long in the first direction.

The energy storage device may have an open circuit voltage (OCV) of 3.6 V or more over 95% or more of a charge-discharge range in which the energy storage device is used.

When a wound electrode assembly containing lithium manganese oxide as a main component in the positive active material is used for the energy storage device, the OCV is maintained at 3.6 V or more even when the SOC is low (for example, when the SOC is 5%). The OCV is maintained at 3.6 V or more in almost the entire charge-discharge range (for example, SOC 5% to SOC 100%) where the energy storage device is used. Thus, overdischarge hardly occurs. For example, even when discharge (for example, 1C discharge) is performed at a high rate under a low temperature environment such as −30° C., there is a margin until the voltage reaches an end-of-discharge voltage (discharge cut voltage), and overdischarge hardly occurs. The end-of-discharge voltage is, for example, 3.0 V.

In comparison, the energy storage device (for example, an LFP battery) including the electrode assembly containing lithium iron phosphate as a main component in the positive active material has an OCV less than 3.6 V in the entire region of the charge-discharge range in which the energy storage device is used.

An energy storage device (for example, NMC 111 battery) including an electrode assembly containing three components of nickel, cobalt, and manganese in a positive active material has an OCV of 3.6 V or more only in a region where the SOC is 50% or more. In a region where the SOC is less than 50%, the OCV is less than 3.6 V, and the lower the SOC, the lower the OCV.

In a method of using the energy storage device, the energy storage device is caused to start discharge when the open circuit voltage (OCV) is 3.6 V or more.

With respect to the energy storage device using the wound electrode assembly containing lithium manganese oxide as a main component in the positive active material, by starting discharge when the open circuit voltage (OCV) is 3.6 V or more, overdischarge can be prevented, and the energy storage device can be suitably used. In general, overdischarge is controlled by controlling a discharge current by a control device or the like; however, there is a possibility that instantaneous overdischarge occurs due to a delay in control response or the like. By using the wound electrode assembly containing lithium manganese oxide as a main component in the positive active material, it is possible to start discharge from a high voltage of 3.6 V or more almost at all times, and therefore, it is possible to sufficiently secure a margin range (margin) up to the end-of-discharge voltage and to prevent overdischarge.

In the above-mentioned use method, the discharge of the energy storage device may be started in a temperature range of −30° C. or lower. Under a low temperature environment, internal resistance of the energy storage device increases, and a voltage drop of the energy storage device due to discharge increases. By using the wound electrode assembly containing lithium manganese oxide as a main component in the positive active material, it is possible to secure the margin up to the end-of-discharge voltage and to prevent overdischarge even under a low temperature environment.

Hereinafter, the present invention will be specifically described with reference to the drawings showing embodiments thereof. In the following description and drawings, a direction parallel to the winding axis of the wound electrode assembly in the energy storage device, that is, a width direction (lateral direction) of the wound electrode assembly is defined as the first direction. A direction orthogonal to the winding axis of the electrode assembly, that is, a height direction (longitudinal direction) of the electrode assembly is defined as the second direction. A direction orthogonal to the winding axis of the electrode assembly, that is, a thickness direction of the electrode assembly is defined as the third direction.

<Energy Storage Device>

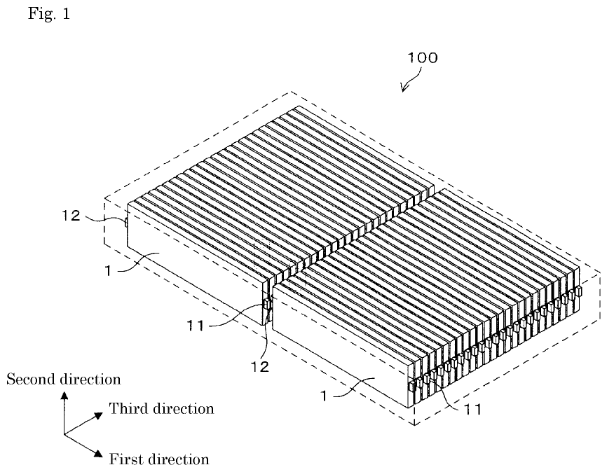

FIG. 1 is a perspective view showing an energy storage apparatus 100 including an energy storage device 1 according to an embodiment. FIG. 1 shows an example of the energy storage apparatus 100 in which energy storage units each including a plurality of the energy storage devices 1 electrically connected to each other are further assembled. The energy storage device 1 has an elongated rectangular parallelepiped shape, and a positive electrode terminal 11 and a negative electrode terminal 12 are provided at the center of both end surfaces. The adjacent positive electrode terminal 11 and negative electrode terminal 12 of the adjacent energy storage devices 1 are connected to each other by a bus bar (not shown) or the like, and the energy storage devices 1 are connected to each other in series. The energy storage apparatus 100 may include a BMU (Battery Management Unit) and/or a CMU (Cell Monitoring Unit) for monitoring the state of the energy storage device 1.

The energy storage device 1 is a battery cell such as a lithium ion secondary battery. The energy storage device 1 is applied to a power supply for a vehicle such as an electric vehicle (EV), a hybrid electric vehicle (HEV), or a plug-in hybrid electric vehicle (PHEV), a power supply for an electronic device, or a power supply for power storage in the state of the energy storage unit or the energy storage apparatus 100 (battery pack) in which the plurality of energy storage devices 1 are electrically connected to each other.

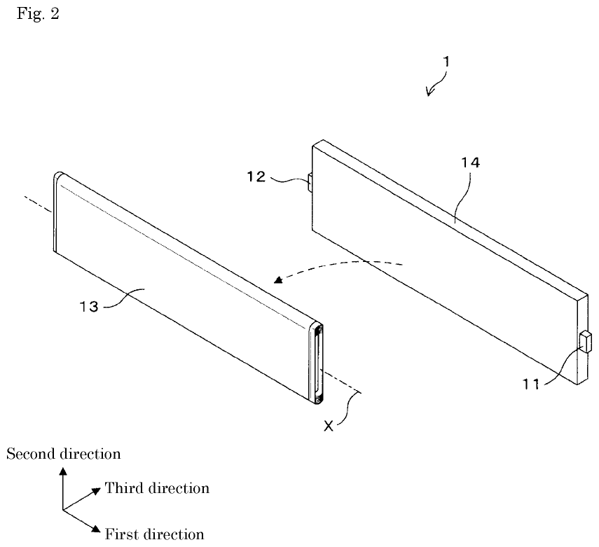

FIG. 2 is an exploded perspective view showing a configuration example of the energy storage device 1. The energy storage device 1 is configured by housing a flat-shaped wound electrode assembly (hereinafter also simply referred to as the electrode assembly) 13 and an electrolyte (not shown) in a hollow rectangular parallelepiped case 14. As a material of the case 14, for example, a metal material such as aluminum or stainless steel is used.

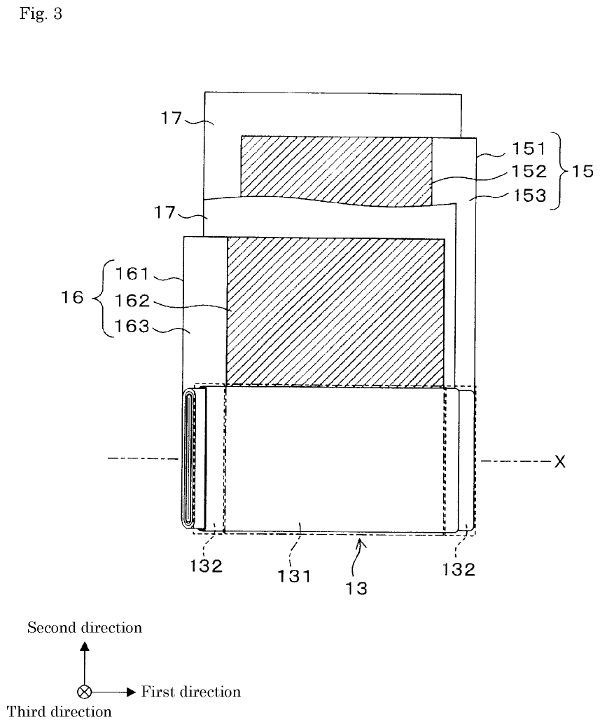

FIG. 3 is a schematic view showing a configuration example of an electrode assembly 13. In FIG. 3, a wound state of the electrode assembly 13 is partially developed. The electrode assembly 13 includes a positive electrode 15, a negative electrode 16, and two sheet-like separators 17. The electrode assembly 13 is formed by stacking the positive electrode 15 and the negative electrode 16 with the separator 17 interposed therebetween and winding the electrodes around a winding axis X.

The positive electrode 15 is a plate in which a positive active material layer 152 is formed on a surface of a sheet-like positive electrode substrate 151 formed from aluminum, an aluminum alloy or the like. The positive electrode 15 includes an uncoated portion 153 of the positive electrode in which the positive active material layer 152 is not formed at one end in the first direction. The negative electrode 16 is a plate in which a negative active material layer 162 is formed on a surface of a sheet-like negative electrode substrate 161 formed from copper, a copper alloy or the like. The negative electrode 16 includes an uncoated portion 163 of the negative electrode in which the negative active material layer 162 is not formed at the other end in the first direction.

The positive electrode 15 and the negative electrode 16 are arranged in a state of being shifted in the first direction. The electrode assembly 13 formed by winding the positive electrode 15 and the negative electrode 16 includes a mixture layer forming portion 131 in which the positive active material layer 152 or the negative active material layer 162 is formed, and a mixture layer non-forming portion 132 excluding the mixture layer forming portion 131. In the example of FIG. 3, the electrode assembly 13 includes the mixture layer forming portion 131 located at the center in the first direction, the mixture layer non-forming portion 132 of the negative electrode located at the left end, and the mixture layer non-forming portion 132 of the positive electrode located at the right end. A negative electrode current collector (not shown) made of metal such as copper is joined to the mixture layer non-forming portion 132 of the negative electrode. The negative electrode 16 is electrically connected to the negative electrode terminal 12 via the negative electrode current collector. A positive electrode current collector (not shown) made of metal such as aluminum is joined to the mixture layer non-forming portion 132 of the positive electrode. The positive electrode 15 is electrically connected to the positive electrode terminal 11 via the positive electrode current collector.

The positive active material layer 152 contains a positive active material. As the positive active material, a material capable of occluding and releasing lithium ions and having the voltage difference corresponding to the change in the SOC in a wide region of the SOC can be used. In the present embodiment, the positive active material contains, as a main component, lithium manganese oxide (LiₓMn_{y}O_{z}) containing lithium and manganese as constituent elements. Specifically, the positive active material contains secondary particles, formed of an aggregate of primary particles of lithium manganese oxide, as active material particles. The secondary particles of lithium manganese oxide are obtained, for example, by mixing a carbon raw material with a lithium manganese oxide powder, firing the mixture, and burning off an additive. Examples of the lithium manganese oxide include LiMnO₂.

The positive active material may further contain another lithium transition metal oxide. The other lithium transition metal oxides preferably have the voltage difference corresponding to the change in the SOC in a wide region of the SOC, similarly to lithium manganese oxide. As the other lithium transition metal oxides, for example, a lithium-nickel-cobalt-manganese composite oxide such as LiNiMnCoO₂ (NMC 111) is preferable. Two or more kinds of other lithium transition metal oxides may be mixed and used.

The positive active material layer 152 may further contain a conduction aid, a binder, a thickener, and the like. Examples of the conduction aid include carbon black such as acetylene black, and carbon materials such as graphite. Examples of the binder include polyvinylidene fluoride (PVDF) and styrene butadiene rubber (SBR). Examples of the thickener include carboxymethylcellulose (CMC) and methylcellulose.

The content of lithium manganese oxide is preferably 50% by weight or more when the whole mixture of lithium manganese oxide and another lithium transition metal oxide is 100% by weight. By adding another lithium transition metal oxide to lithium manganese oxide within the above range, the effect of the present invention can be further enhanced, the energy density of the energy storage device can be improved, and good safety can be provided. The content of lithium manganese oxide is more preferably 70% by weight or more, and still more preferably 100% by weight.

The negative active material layer 162 contains a negative active material. As the negative active material, a material capable of occluding and releasing lithium ions can be used. Examples of the negative active material include carbon materials such as graphite, hard carbon, and soft carbon. The negative active material layer may further contain a conduction aid, a binder, a thickener, and the like. As the conduction aid, the binder, the thickener, and the like, those similar to the positive active material layer 152 can be used.

The separator 17 is formed of a porous resin film. As the porous resin film, a porous resin film made of a resin such as polyethylene (PE) or polypropylene (PP) can be used. The separator 17 may be formed of a resin film having a single-layer structure, or may be formed of a resin film having a multilayer structure of two or more layers. The separator 17 may include a heat resistant layer.

As the electrolyte housed in the case 14 together with the electrode assembly 13, the same electrolyte as that of a conventional lithium ion battery can be used. For example, an electrolyte containing a supporting salt in an organic solvent can be used as the electrolyte. Examples of the organic solvent include aprotic solvents such as carbonates, esters, and ethers. Examples of the supporting salt include lithium salts such as LiPF₆, LiBF₄, and LiClO₄. The electrolyte may contain, for example, various additives such as a gas generating agent, a film forming agent, a dispersant, and a thickener.

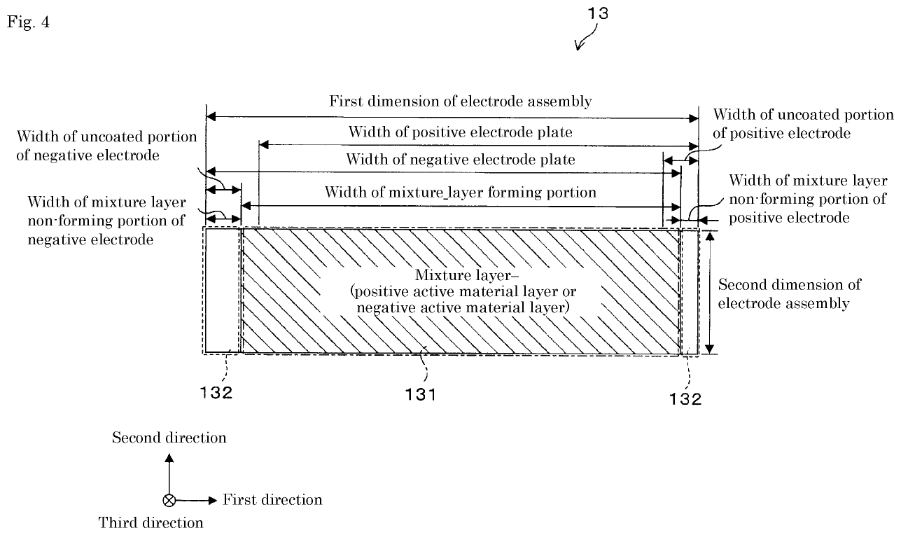

FIG. 4 is an explanatory view for explaining the configuration example of the electrode assembly 13. With reference to FIG. 4, a ratio between the dimension in the first direction (hereinafter also referred to as the first dimension) and the dimension in the second direction (hereinafter also referred to as the second dimension) of the electrode assembly 13 in the present embodiment will be described. FIG. 4 is a plan view of the electrode assembly 13 as viewed from the third direction perpendicular to a plane parallel to the first direction and the second direction. The electrode assembly 13 has a rectangular shape in plan view. The first direction corresponds to the width direction of the electrode assembly 13, and the second direction corresponds to the height direction of the electrode assembly 13.

The electrode assembly 13 includes the mixture layer forming portion 131 in which the positive active material layer 152 or the negative active material layer 162 is formed, and the mixture layer non-forming portion 132 of the negative electrode and the mixture layer non-forming portion 132 of the positive electrode which are provided at both ends in the first direction. In the present embodiment, the width of the mixture layer forming portion 131 corresponds to the width of the negative active material layer 162. The width of the mixture layer non-forming portion 132 of the negative electrode corresponds to the width of the uncoated portion 163 of the negative electrode. The width of the mixture layer non-forming portion 132 of the positive electrode corresponds to a value obtained by subtracting an overlapping portion of the negative electrode substrate 161 from the width of the uncoated portion 153 of the positive electrode. The first dimension is a dimension obtained by summing the widths of the mixture layer forming portion 131, the mixture layer non-forming portion 132 of the negative electrode, and the mixture layer non-forming portion 132 of the positive electrode. The second dimension is a dimension of the electrode assembly 13 in the second direction.

The ratio of the first dimension to the second dimension (first dimension/second dimension) of the electrode assembly 13 is 1.45 or more. When the first dimension/the second dimension is 1.45 or more, the energy density can be improved. From the viewpoint of improving the energy density, the first dimension/the second dimension is preferably 1.82 or more.

In the energy storage device 1, when the electrode assembly 13 is formed by winding the plate around the winding axis, there are a horizontally wound electrode assembly in which the winding axis extends in a vertical direction (longitudinal direction) and a vertically wound electrode assembly in which the winding axis extends in a horizontal direction (lateral direction). In general, the energy density of the horizontally wound electrode assembly is higher than that of the vertically wound electrode assembly in terms of space efficiency and the like in the case 14. However, when the electrode assembly 13 is elongated in the lateral direction, the space efficiency in the case 14 is reversed between the horizontally wound electrode assembly and the vertically wound electrode assembly, and the energy density of the vertically wound electrode assembly is higher than that of the horizontally wound electrode assembly.

Specifically, in the horizontally wound electrode assembly, even when the electrode assembly 13 is elongated in the lateral direction, the ratio of the mixture layer forming portion 131 of the plate in the case 14 does not change much. On the other hand, in the vertically wound electrode assembly, when the electrode assembly 13 is elongated in the lateral direction, the ratio of the mixture layer forming portion 131 of the plate to the mixture layer non-forming portion 132 is increased, so that the ratio of the mixture layer forming portion 131 of the plate in the case 14 is increased. The mixture layer forming portion 131 is a region in which an occlusion/desorption reaction of lithium ions is performed. The mixture layer non-forming portion 132 is a portion where the substrate is exposed, and therefore is a region where the occlusion/desorption reaction of lithium ions is not performed. When the ratio between the first dimension and the second dimension in the electrode assembly 13 of the vertical winding type is 1.45 or more, the ratio of the mixture layer forming portion 131 of the plate in the case 14 can be increased, and the energy density can be improved as compared with the horizontal winding type.

In the above description, the example has been described in which the uncoated portion 153 of the positive electrode and the uncoated portion 163 of the negative electrode are respectively provided at both ends of the electrode assembly 13 in the first direction. Alternatively, in the electrode assembly 13, both the uncoated portion 153 of the positive electrode and the uncoated portion 163 of the negative electrode may be provided at one end in the first direction, and both the uncoated portion 153 of the positive electrode and the uncoated portion 163 of the negative electrode may be provided at both ends in the first direction.

<Method of Manufacturing Energy Storage Device>

An example of a method of manufacturing the energy storage device 1 according to the embodiment of the present invention will be described.

First, the positive electrode 15 and the negative electrode 16 are prepared. The positive electrode 15 is prepared by applying a positive composite paste directly or via an intermediate layer to the positive electrode substrate 151 and drying the paste. At this time, the coating position of the positive composite paste is adjusted so that the uncoated portion 153 of the positive electrode is formed at one end of the positive electrode 15. The positive composite paste contains components constituting the positive active material layer 152 such as a positive active material and a dispersion medium. The positive active material contains the lithium manganese oxide. Similarly, the negative electrode 16 is prepared by applying a negative composite paste directly or via an intermediate layer to the negative electrode substrate 161 and drying the paste. At this time, the coating position of the negative composite paste is adjusted so that the uncoated portion 163 of the negative electrode is formed at one end of the negative electrode 16. The negative composite paste contains components constituting the negative active material layer 162 such as a negative active material and a dispersion medium.

The positive electrode 15 and the negative electrode 16 are cut to prescribed dimensions. The positive electrode 15, the negative electrode 16, and the separator 17 are wound in a prescribed length around the winding axis X to prepare the electrode assembly 13 having a prescribed first dimension/second dimension. The positive electrode current collector (positive electrode terminal tab) is joined to the mixture layer non-forming portion 132 of the positive electrode in the electrode assembly 13, and the negative electrode current collector (negative electrode terminal tab) is joined to the mixture layer non-forming portion 132 of the negative electrode.

The electrode assembly 13 and the electrolyte are housed from an opening of the case 14. The positive electrode current collector is connected to the positive electrode terminal 11, and the negative electrode current collector is connected to the negative electrode terminal 12. The opening of the case 14 is covered and joined by welding, an adhesive, or the like. Accordingly, a battery (energy storage device 1) is obtained.

<Method of Using Energy Storage Device>

In the use method according to the embodiment of the present invention, the energy storage device 1 is caused to start discharge when the open circuit voltage (OCV) is 3.6 V or more. In the above-mentioned use method, the discharge may be started in the temperature range of −30° C. or lower.

By starting discharge from a high voltage state where the open circuit voltage (OCV) is 3.6 V or more, a margin up to the end-of-discharge voltage can be sufficiently secured, and overdischarge can be prevented. In particular, even under a low temperature environment such as −30° C. where the internal resistance increases, the margin up to the end-of-discharge voltage can be sufficiently secured.

### EXAMPLES

In the following, the present invention will be described in more detail with reference to Examples and Comparative Examples. However, the present invention is not intended to be limited to these Examples.

### Example 1

By the same steps as in the above-mentioned manufacturing method, an energy storage device of Example 1 using a vertically wound electrode assembly having dimensions shown in Table 1 below and shown below and containing LiMnO₂ as a main component in the positive active material was produced. Graphite was used as a main component for the negative active material.

In the energy storage device of Example 1, dimensions other than the first dimension are as follows.
Electrode assembly: second dimension (height) 135.6 mm, thickness 19.37 mm
Case: width 200 mm, height 145 mm, thickness 22 mm (without including electrode terminal portion)
Positive electrode substrate: width 180.4 mm
Positive active material layer: width 166.2 mm
Uncoated portion of positive electrode: 14.2 mm
Negative electrode substrate: width 184.5 mm
Negative active material layer: width 170.3 mm
Uncoated portion of negative electrode: 14.2 mm
Positive electrode terminal tab and negative electrode terminal tab: width 13.1 mm

TABLE 1

| | Electrode assembly | |
|---|---|---|
| | First dimension | First dimension/second dimension |
| Example 1 | 196.65 | 1.45 |
| Example 2 | 246.65 | 1.82 |
| Example 3 | 296.65 | 2.19 |
| Example 4 | 596.65 | 4.40 |
| Example 5 | 896.65 | 6.61 |
| Example 6 | 1196.65 | 8.82 |
| Example 7 | 1496.65 | 11.04 |
| Example 8 | 1996.65 | 14.72 |
| Comparative | 96.65 | 0.71 |
| Example 1 | | |
| Comparative | 146.65 | 1.08 |
| Example 2 | | |
| Comparative | 96.65 | 0.71 |
| Example 3 | | |
| Comparative | 146.65 | 1.08 |
| Example 4 | | |
| Comparative | 196.65 | 1.45 |
| Example 5 | | |
| Comparative | 246.65 | 1.82 |
| Example 6 | | |
| Comparative | 296.65 | 2.19 |
| Example 7 | | |
| Comparative | 596.65 | 4.40 |
| Example 8 | | |
| Comparative | 896.65 | 6.61 |
| Example 9 | | |
| Comparative | 1196.65 | 8.82 |
| Example 10 | | |
| Comparative | 1496.65 | 11.04 |
| Example 11 | | |
| Comparative | 1996.65 | 14.72 |
| Example 12 | | |
| Comparative | 196.65 | 1.45 |
| Example 13 | | |
| Comparative | 246.65 | 1.82 |
| Example 14 | | |

### Examples 2 to 8

Energy storage devices of Examples 2 to 8 were produced similarly to Example 1 except that the first dimension/the second dimension of the electrode assembly was set as shown in Table 1, and the width of the mixture layer forming portion of the electrode assembly and the width of the case were changed. In Examples 2 to 8, the widths of the positive active material layer and the negative active material layer (mixture layer forming portion) of the electrode assembly were increased according to a difference between the first dimension of the electrode assembly in each Example and the first dimension of the electrode assembly in Example 1. The second dimension of the electrode assembly was unified to 135.6 mm, and the thickness was unified to 19.37 mm. Similarly, the width of the case was increased according to the difference between the first dimensions of the electrode assembly. The height of the case was unified to 145 mm, and the thickness was unified to 22 mm.

### Comparative Examples 1 to 2

Energy storage devices of Comparative Examples 1 to 2 were produced similarly to Example 1 except that the first dimension/the second dimension of the electrode assembly was set as shown in Table 1, and the width of the mixture layer forming portion of the electrode assembly and the width of the case were changed. Similarly to Examples 2 to 8, the width of the mixture layer forming portion and the width of the case were decreased according to a difference between the first dimension of the electrode assembly in each Comparative Example and the first dimension of the electrode assembly in Example 1.

### Comparative Examples 3 to 12

Energy storage devices of Comparative Examples 3 to 12 were produced similarly to Example 1 except that LiFePO₄ was used as a main component of the positive active material, the first dimension/the second dimension of the electrode assembly was set as shown in Table 1, and the width of the mixture layer forming portion of the electrode assembly and the width of the case were changed. Similarly to Examples 2 to 8, the width of the mixture layer forming portion and the width of the case were increased or decreased according to the difference between the first dimension of the electrode assembly in each Comparative Example and the first dimension of the electrode assembly in Example 1.

### Comparative Examples 13 to 14

Energy storage devices of Comparative Examples 13 to 14 were produced similarly to Example 1 except that LiCoO₂ was used as a main component of the positive active material, the first dimension/the second dimension of the electrode assembly was set as shown in Table 1, and the width of the mixture layer forming portion of the electrode assembly and the width of the case were changed. Similarly to Examples 2 to 8, the width of the mixture layer forming portion and the width of the case were increased or decreased according to the difference between the first dimension of the electrode assembly in each Comparative Example and the first dimension of the electrode assembly in Example 1.

<Volume Energy Density>

The volume energy density of the energy storage devices of Examples 1 to 8 and Comparative Examples 1 to 14 was examined. The energy storage devices of Examples 1 to 8 and Comparative Examples 1 to 14 were subjected to a charge-discharge test. In the energy storage devices of Examples 1 to 8 and Comparative Examples 1 to 2, constant current constant voltage charge was performed at a rate of 0.2 C and a voltage of 4.2 V for 7.5 hours, and constant current discharge was performed at a rate of 0.2 C and a cut voltage of 3.0 V. In the energy storage devices of Comparative Examples 3 to 12, constant current constant voltage charge was performed at a rate of 0.2 C and a voltage of 3.5 V for 7.5 hours, and constant current discharge was performed at a rate of 0.2 C and a cut voltage of 2.5 V. In the energy storage devices of Comparative Examples 13 to 14, constant current constant voltage charge was performed at a rate of 0.2 C and a voltage of 4.1 V for 7.5 hours, and constant current discharge was performed at a rate of 0.2 C and a cut voltage of 3.0 V. The discharge capacity (mAh) in this case was obtained by calculation. A value obtained by multiplying the discharge capacity (mAh/cm 3) per volume, obtained by dividing the calculated discharge capacity (mAh) by the case size (cm 3), by the voltage (V) at the time of discharge was defined as the volume energy density (Wh/L). The results are shown in Table 2 below.

The volume energy density of the energy storage device was determined by calculation in the case of using the same material as in each of Examples 1 to 8 and Comparative Examples 1 to 14 and using a horizontally wound electrode assembly designed so that a ratio of the second dimension/the first direction was the same. A difference in volume energy density between the vertical winding type and the horizontal winding type is also shown in Table 2 below.

TABLE 2

| | Energy density (Wh/L) | | | |
|---|---|---|---|---|
| | Vertical | Horizontal | Vertical winding − | Nail |
| | winding | winding | horizontal winding | penetration |
| Example 1 | 316.63 | 316.55 | 0 | ◯ |
| Example 2 | 328.86 | 321.97 | 7 | ◯ |
| Example 3 | 337.49 | 325.58 | 12 | ◯ |
| Example 4 | 358.92 | 334.62 | 24 | ◯ |
| Example 5 | 366.06 | 337.63 | 28 | ◯ |
| Example 6 | 369.63 | 339.14 | 30 | ◯ |
| Example 7 | 371.77 | 340.04 | 32 | ◯ |
| Example 8 | 373.92 | 340.94 | 33 | ◯ |
| Comparative | 251.79 | 275.66 | −24 | ◯ |
| Example 1 | | | | |
| Comparative | 294.64 | 307.51 | −13 | ◯ |
| Example 2 | | | | |
| Comparative | 179.85 | 196.90 | −17 | ◯ |
| Example 3 | | | | |
| Comparative | 210.46 | 219.65 | −9 | ◯ |
| Example 4 | | | | |
| Comparative | 226.16 | 226.11 | 0 | ◯ |
| Example 5 | | | | |
| Comparative | 234.90 | 229.98 | 5 | ◯ |
| Example 6 | | | | |
| Comparative | 241.07 | 232.56 | 9 | ◯ |
| Example 7 | | | | |
| Comparative | 256.37 | 239.01 | 17 | ◯ |
| Example 8 | | | | |
| Comparative | 261.47 | 241.16 | 20 | ◯ |
| Example 9 | | | | |
| Comparative | 264.02 | 242.24 | 22 | ◯ |
| Example 10 | | | | |
| Comparative | 265.55 | 242.89 | 23 | ◯ |
| Example 11 | | | | |
| Comparative | 267.08 | 243.53 | 24 | ◯ |
| Example 12 | | | | |
| Comparative | 386.74 | 386.64 | 0 | X White smoke |
| Example 13 | | | | |
| Comparative | 401.68 | 393.26 | 8 | X White smoke |
| Example 14 | | | | |

<Nail Penetration Test>

After the energy storage devices of Examples 1 to 8 and Comparative Examples 1 to 14 were fully charged, a nail penetration test was performed in which a nail having a diameter of 5 mm was penetrated into the energy storage device having a diameter of 7 mm. Good/not-good determination of the result of the nail penetration test was performed by the presence or absence of smoking or firing. The results are also shown in Table 2 above. In Table 2, a case where there was no smoking or firing was described as ∘, and a case where there was smoking or firing was described as x.

As is apparent from Table 2, when the winding direction of the electrode assembly was the vertical winding, the first dimension/the second dimension was 1.45, so that the energy density was the same as that in the case of the horizontal winding, and when the first dimension/the second dimension was 1.82 or more, so that the energy density was higher than that in the case of the horizontal winding. When the first dimension/the second dimension was less than 1.45, the energy density was lower than that in the case of the horizontal winding. It was confirmed that when the first dimension/the second dimension was 1.45 or more, the energy density of the wound electrode assembly having a vertically wound structure could be improved.

The energy storage devices containing lithium manganese oxide of Examples 1 to 8 had a high energy density and good safety. In Examples 1 to 8, the energy density was 316 Wh/L or more. The energy storage devices containing lithium iron phosphate of Comparative Examples 5 to 12 had good safety, but had a lower energy density than Examples 1 to 8. In the energy storage devices containing lithium cobalt oxide of Comparative Examples 13 to 14, although the energy density was high, the safety at the time of nail penetration was insufficient, and white smoke was confirmed. It was confirmed that by using lithium manganese oxide as a main component of the positive active material, an energy storage device having high energy density and good safety could be provided.

<Discharge Performance Characteristics>

The discharge performance characteristics of the energy storage devices produced in Example 2 and Comparative Example 6 were examined. A discharge test was performed at the discharge rate and the ambient temperature shown in Table 3 below to measure the discharge capacity of the energy storage device. The discharge cut voltage in the energy storage device of Example 2 was 2 V, and the discharge cut voltage in the energy storage device of Comparative Example 6 was 2.3 V. A value obtained by dividing the discharge capacity at the time of discharge at each discharge rate and ambient temperature by the discharge capacity at the time of discharge at a discharge rate of 0.5 C and a temperature of 25° C. was taken as the discharge capacity (percentage).

TABLE 3

| | |
|---|---|
| Discharge rate | Discharge capacity (%) |

| | (C) | 25° C. | −30° C. |
|---|---|---|---|
| Example 2 | 0.5 | 100 | 70 |
| | 1.0 | 100 | 65 |
| | 2.0 | 99 | 63 |
| | 3.0 | 99 | 62 |
| | 5.0 | 98 | 60 |
| | 10.0 | 98 | 40 |
| Comparative | 0.5 | 100 | 52 |
| Example 6 | 1.0 | 100 | 50 |
| | 2.0 | 99 | 51 |
| | 3.0 | 99 | 52 |
| | 5.0 | 98 | 57 |
| | 10.0 | 98 | 27 |

As is apparent from Table 3, the energy storage device of Example 2 exhibited a high discharge capacity even under a low temperature environment. In the energy storage device of Example 2, when the temperature was −30° C., the discharge capacity was 70% at a discharge rate of 0.5 C, and the discharge capacity was 40% even at high rate discharge of a discharge rate of 10 C. In the energy storage device of Comparative Example 6, when the temperature was −30° C., the discharge capacity decreased to 52% at a discharge rate of 0.5 C, and the discharge capacity decreased to 27% at a discharge rate of 10 C. It was confirmed that the energy storage device of Example 2 could reduce the decrease in discharge capacity under a low temperature environment. By using lithium manganese oxide as a main component of the positive active material, it is possible to provide an energy storage device having good discharge performance characteristics over a wide temperature range.

<Cycle Performance>

Cycle performance of the energy storage devices produced in Example 2 and Comparative Example 6 was examined under two temperature environments shown in Table 4 below. Charge and discharge were repeated under two temperature environments of 25° C. and −10° C. Specifically, the energy storage device was stored at ambient temperatures of 25° C. and −10° C., subjected to constant current constant voltage charge at a charge rate of 1 C for 1.5 hours, and then paused for a predetermined time. The constant voltage charge in the energy storage device of Example 2 was 4.2 V, and the constant voltage charge in the energy storage device of Comparative Example 6 was 3.5 V. Next, after constant current discharge was performed at a discharge rate of 1 C, the discharge was paused for a predetermined time. The discharge cut voltage in the energy storage device of Example 2 was 3.0 V, and the discharge cut voltage in the energy storage device of Comparative Example 6 was 2.5 V. This charge-discharge cycle was repeated, and the discharge capacity of the energy storage device in each cycle was measured.

A value obtained by dividing the discharge capacity at the time of discharge at each cycle by the discharge capacity at the time of discharge at the first cycle was defined as an initial capacity ratio (percentage, also referred to as a capacity retention ratio), and the number of cycles at which the initial capacity ratio was 80% was examined. The number of cycles at which the initial capacity ratio becomes 80% is the number of cycles when the initial capacity ratio decreases to 80% for the first time when charge and discharge are repeated. The results are also shown in Table 4 below.

TABLE 4

Number of cycles at which
initial capacity ratio is 80%

| | 25° C. | −10° C. |
|---|---|---|
| Example 2 | 1,200 | 850 |
| Comparative Example 6 | 1,050 | 100 |

As is apparent from Table 4, it was found that the energy storage device of Example 2 maintained the initial capacity ratio of 80% or more until the 850-th cycle under a low temperature environment of −10° C., and deterioration under the low temperature environment was small. On the other hand, it was found that in the energy storage device of Comparative Example 6, the initial capacity ratio decreased to 80% at the 100-th cycle under the low temperature environment of −10° C., and the deterioration under the low temperature environment was large. It was confirmed that by using lithium manganese oxide as a main component of the positive active material, an energy storage device having good cycle performance over a wide temperature range could be provided.

The embodiment disclosed herein is illustrative in all respects and is not restrictive. The scope of the present invention is defined by the claims, and includes all modifications within meanings and the scopes equivalent to the claims.

1. An energy storage device comprising:
a wound electrode assembly containing lithium manganese oxide as a main component in a positive active material; and
a case that houses the wound electrode assembly,
wherein
the wound electrode assembly includes a mixture layer forming portion in which a mixture layer is formed, and a mixture layer non-forming portion located at least at one end in a first direction parallel to a winding axis, and
in the wound electrode assembly, a ratio of a dimension in the first direction to a dimension in a second direction orthogonal to the first direction in plan view is 1.45 or more.

2. The energy storage device according to claim 1, wherein the ratio of the dimension in the first direction to the dimension in the second direction is 1.82 or more.

3. The energy storage device according to claim 1, wherein
an open circuit voltage (OCV) is 3.6 V or more over 95% or more of a charge-discharge range in which the energy storage device is used.

4. A method of using an energy storage device, comprising causing the energy storage device according to claim 1 to start discharge when an open circuit voltage (OCV) is 3.6 V or more.

5. The method of using an energy storage device according to claim 4, wherein discharge is started in a temperature range of −30° C. or lower.

6. The energy storage device according to claim 2, wherein an open circuit voltage (OCV) is 3.6 V or more over 95% or more of a charge-discharge range in which the energy storage device is used.

7. A method of using an energy storage device, comprising causing the energy storage device according to claim 2 to start discharge when an open circuit voltage (OCV) is 3.6 V or more.

8. A method of using an energy storage device, comprising causing the energy storage device according to claim 3 to start discharge when an open circuit voltage (OCV) is 3.6 V or more.
